(19) United States
(12) Patent Application Publication
(10) Pub. No.: US 2011/0317635 A1
(43) Pub. Date: Dec. 29, 2011

(54) APPARATUS AND METHOD FOR RECEIVING CELL SYSTEM INFORMATION DURING AUTONOMOUS GAPS

(75) Inventor: Arvind Swaminathan, San Diego, CA (US)

(73) Assignee: QUALCOMM INCORPORATED, San Diego, CA (US)

(21) Appl. No.: 12/970,616

(22) Filed: Dec. 16, 2010

Related U.S. Application Data
(60) Provisional application No. 61/288,157, filed on Dec. 18, 2009.

(51) Int. Cl. H04W 72/08

(52) U.S. Cl. 370/329

(57) ABSTRACT

Methods and apparatuses are provided that facilitate receiving signals from one or more base stations while communicating with a serving base station. Devices can receive the signals in autonomous gaps, during which the device can tune away to receive the signals. A device can report a low channel quality indicator (CQI) value to the serving base station prior to the autonomous gap to decrease a likelihood that the base station will schedule transmissions to the device, or at least decrease a data rate for transmissions. In another example, the device can report a CQI reserved for indicating starting an autonomous gap. In either case, the described methods and apparatuses can minimize data loss during the autonomous gap. Once the device returns from receiving the signals, the device can report an improved or actual CQI value to the base station to resume communications.

### CLAIM OF PRIORITY UNDER 35 U.S.C. §119

The present Application for Patent claims priority to Provisional Application No. 61/288,157 entitled “IMPROVING PERFORMANCE DURING AUTONOMOUS GAPS IN LONG TERM EVOLUTION USER EQUIPMENT,” filed Dec. 18, 2009, and assigned to the assignee hereof and hereby expressly incorporated by reference herein.

### BACKGROUND

1. Field

The following description relates generally to wireless communications, and more particularly to measuring cells to determine related system information.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

In addition, to supplement macro cell base station coverage, relay nodes, small-coverage base stations (e.g., home evolved node B (HeNB), femtocell or picocell base stations, and/or the like), etc. can be deployed in a wireless network to provide increased coverage at the cell edge, improved data rates, diverse service offerings, in-building coverage, and/or the like. Typically, small-coverage base stations can be connected to the Internet and the mobile operator network via broadband connection, such as digital subscriber line (DSL), cable modem, etc. The small-coverage base stations can be deployed without restriction or planning, and thus can conflict with one another (and/or with a macro cell base station). In one example, a mobile device can read system information from one or more small-coverage access points for providing to a macro cell base station to handle such conflicts. The mobile device, in this example, can read the system information during one or more autonomous gaps defined by the mobile device, during which a serving base station may transmit signals to the mobile device, which can result in lost data.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more embodiments and corresponding disclosure thereof, various aspects are described in connection with reading system information from one or more surrounding base stations while mitigating impact to serving base station communications. For example, prior to reading system information in an autonomous gap, a device can report low channel quality over control resources to the serving base station to decrease likelihood that the serving base station will schedule device communications in the autonomous gap or at least decrease a data rate. When the device returns from reading system information for the one or more surrounding base stations, it can report higher (or actual) channel quality to the serving base station to resume communications. In another example, the device can report a channel quality value to the serving base station that is reserved to indicate a subsequent autonomous gap. In this example, the base station can refrain from communicating with the device until a different channel quality value is received therefrom (e.g., or until expiration of a timer, etc.).

According to an example, a method for minimizing data loss in autonomous gaps is provided that includes determining to receive signals from one or more base stations different from a serving base station and selecting a channel quality indicator (CQI) value for the serving base station based at least in part on the determining to receive signals. The method further includes reporting the CQI value to the serving base station.

In another aspect, a wireless communications apparatus for minimizing data loss in autonomous gaps is provided that includes at least one processor configured to initialize an autonomous gap for receiving signals from one or more base stations different from a serving base station and select a CQI value for indicating the autonomous gap. The at least one processor is further configured to report the CQI value to the serving base station. In addition, the wireless communications apparatus includes a memory coupled to the at least one processor.

In yet another aspect, an apparatus for minimizing data loss in autonomous gaps is provided that includes means for determining to receive signals from one or more base stations different from a serving base station during an autonomous gap. The apparatus further includes means for reporting a CQI value to the serving base station based at least in part on the means for determining determining to receive the signals during the autonomous gap.

Still, in another aspect, a computer-program product is provided for minimizing data loss in autonomous gaps including a computer-readable medium having code for causing at least one computer to initialize an autonomous gap for receiving signals from one or more base stations different from a serving base station. The computer-readable medium further includes code for causing the at least one computer to select a CQI value for indicating the autonomous gap and code for causing the at least one computer to report the CQI value to the serving base station.

Moreover, in an aspect, an apparatus for minimizing data loss in autonomous gaps is provided that includes a base station analyzing component for determining to receive signals during an autonomous gap from one or more base stations different from a serving base station. The apparatus further includes a CQI reporting component for communicating a CQI value to the serving base station based at least in part on the base station analyzing component determining to receive signals during the autonomous gap.

According to another example, a method of wireless communication is provided that includes receiving a CQI value from a device that indicates starting an autonomous gap and ceasing transmitting data to the device based at least in part on receiving the CQI value

In another aspect, a wireless communications apparatus for determining an autonomous gap is provided that includes at least one processor configured to receive a CQI value from a device that indicates starting an autonomous gap. The at least one processor is further configured to cease transmitting data to the device based at least in part on receiving the CQI value. In addition, the wireless communications apparatus includes a memory coupled to the at least one processor.

In yet another aspect, an apparatus for determining an autonomous gap is provided that includes means for receiving a CQI value from a device that indicates starting an autonomous gap. The apparatus further includes means for ceasing transmitting data to the device based at least in part on receiving the CQI value.

Still, in another aspect, a computer-program product is provided for determining an autonomous gap including a computer-readable medium having code for causing at least one computer to receive a CQI value from a device that indicates starting an autonomous gap. The computer-readable medium further includes code for causing the at least one computer to cease transmitting data to the device based at least in part on receiving the CQI value.

Moreover, in an aspect, an apparatus for determining an autonomous gap is provided that includes an autonomous gap determining component for receiving a CQI value from a device that indicates starting an autonomous gap. The apparatus further includes a resource scheduling component for ceasing transmitting data to the device based at least in part on receiving the CQI value.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example system for analyzing base stations while communicating with a serving base station.

FIG. 2 illustrates an example system for reporting a channel quality indicator (CQI) value to a serving base station for analyzing one or more other base stations.

FIG. 3 illustrates an example system that facilitates signaling an autonomous gap to a base station.

FIG. 4 illustrates an example methodology that facilitates reporting CQI to indicate determining to receive signals from other base stations.

FIG. 5 illustrates an example methodology that facilitates controlling transmissions to devices based at least in part on determining an autonomous gap.

FIG. 6 illustrates an example methodology for ceasing and continuing transmissions to a device based on reported CQI values.

FIG. 7 illustrates an example system for reporting CQI to indicate determining to receive signals from other base stations.

FIG. 8 illustrates an example system for controlling transmissions to devices based at least in part on determining an autonomous gap.

FIG. 9 is an illustration of a wireless communication system in accordance with various aspects set forth herein.

FIG. 10 is an illustration of an example wireless network environment that can be employed in conjunction with the various systems and methods described herein.

FIG. 11 illustrates a wireless communication system, configured to support a number of devices, in which the aspects herein can be implemented.

FIG. 12 illustrates an exemplary communication system to enable deployment of femtocells within a network environment.

FIG. 13 illustrates an example of a coverage map having several defined tracking areas.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described further herein, a device can transmit a signal to a serving base station prior to measuring or otherwise receiving signals from one or more other base stations (e.g., relating to one or more cells thereof). For example, the signal to the serving base station can indicate low channel quality feedback to the serving base station to lessen a likelihood that the serving base station will schedule the device over resources where low channel quality feedback is received or at least decrease a data rate utilized by the serving base station over the resources. Subsequently, the device can measure or otherwise communicate with one or more other base stations. Once this process is complete, the device can communicate (e.g. via another signal) a higher channel quality feedback (or an actual channel quality feedback, for example) to the serving base station to facilitate subsequently communicating therewith. In another example, a channel feedback quality value can be reserved for indicating such measurement or receiving of other base station signals, and the device can communicate the value to the serving base station prior to performing the measurement or receiving. Thus, the described aspects reduce or avoid data loss in communications with a first base station by transmitting an indicator signal prior to measuring/receiving signals from another base station.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

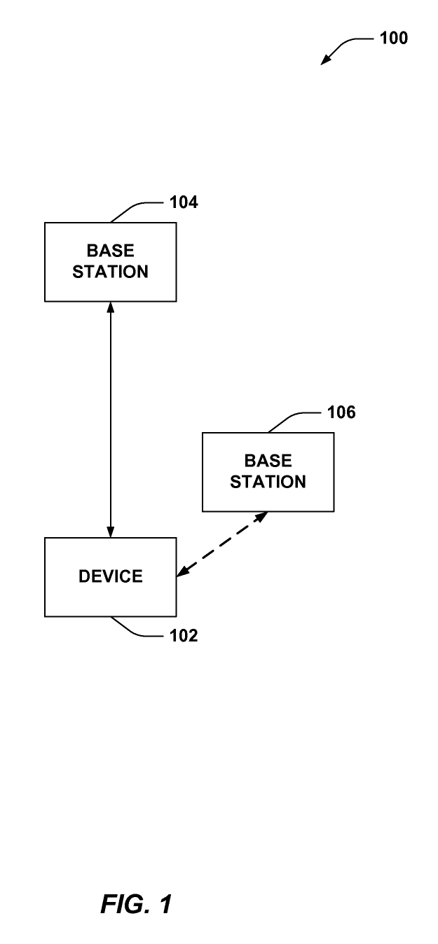

Referring to FIG. 1, illustrated is a wireless communication system 100 that facilitates measuring base stations for performing handover. System 100 includes a device 102 that can communicate with a base station 104 to access a wireless network (not shown). For example, device 102 can be a UE, modem (or other tethered device), a portion thereof, or substantially any device that can communicate with a base station in a wireless network. Moreover, device 102 can move throughout a wireless network and can encounter another base station 106. In addition, base stations 104 and 106 can each be, for example, a macrocell, femtocell, picocell, or similar base station, relay node, mobile base station, UE (e.g., communicating in peer-to-peer or ad-hoc mode with device 102), a portion thereof, and/or substantially any device that provides one or more disparate devices with access to a wireless network.

According to an example, device 102 can communicate with base station 104 to receive access to a wireless network, and can provide measurement reports to base station 104 regarding one or more neighboring base stations. Based at least in part on the measurement reports, base station 104 can initiate handover of device 102 to the one or more neighboring base stations where one or more communication metrics in the measurement report are more favorable than that of base station 104 (e.g., beyond a threshold difference or otherwise). In an example, the one or more neighboring base stations can be femtocell base stations, or similar base stations, that can be deployed within the coverage of base station 104. In this example, some of the femtocell base stations can utilize the same physical cell identifier (PCI), which can inhibit uniquely identifying each femtocell base station for initiating the handover. In this regard, device 102 can read additional information from the one or more neighboring base stations so base station 104 can distinguish the neighboring base stations despite conflicting PCIs.

Thus, in an example, device 102 can move within sufficient range of base station 106 such that it becomes a candidate for handover (e.g., where signal quality of base station 106 is better than that of base station 104 by at least a threshold difference). Device 102 can accordingly acquire additional system information regarding base station 106 (e.g., where base station 106 is a femtocell or similar base station), as described, in an autonomous gap defined by device 102. For example, the autonomous gap can relate to a period of time during which device 102 can tune away from a current frequency and measure other neighboring cells. In addition, in one example, device 102 can acquire the additional information for each base station during the autonomous gap based on a request from base station 104, in response to identifying base station 106 as a femtocell base station, and/or the like. In an example, device 102 can define the autonomous gap, such that base station 104 may not be aware of the autonomous gap and may try to otherwise communicate with device 102 during the gap. Thus, for example, device 102 can signal to base station 104 prior to the autonomous gap period.

In one example, device 102 can report a channel quality indicator (CQI) to the base station 104 for resources assigned by the base station 104 to device 102 at less than a threshold level before the autonomous gap period. This can decrease a likelihood that base station 104 will schedule resources to the device 102 for transmitting data during the autonomous gap period. Where base station 104 does transmit data to the device 102 during the autonomous gap period, for example, it can at least lower the data rate based at least in part on the lower CQI, resulting in less data loss. In another example, device 102 can signal a CQI value to base station 104 that indicates the device 102 is acquiring additional information from base station 106. In either case, for example, once the device 102 obtains the system information from base station 106, it can report a higher (or actual) CQI to the base station 104, and the base station 104 can schedule resources to the device 102 for communicating therewith and/or increase the data rate.

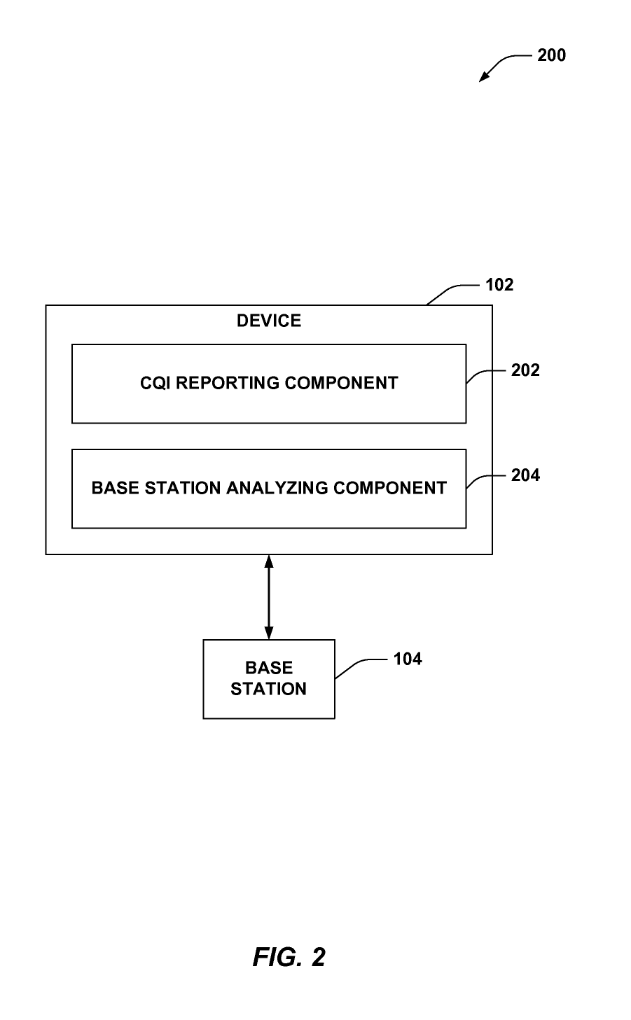

Turning to FIG. 2, illustrated is an example wireless communications system 200 that facilitates obtaining system information from a base station while communicating with a serving base station. System 200 comprises a device 102, which as described can communicate with a base station 104 to receive wireless network access. In this regard, for example, base station 104 can be a serving base station 104 of device 102. Device 102 can comprise a CQI reporting component 202 that transmits CQI values to a serving base station related to resources provided to the device 102 for communicating therewith, and a base station analyzing component 204 that can receive signals from other base stations (e.g., during handover or a similar procedure).

According to an example, base station 104 can communicate with device 102 over downlink resources allocated to the device 102. In addition, device 102 can report control data over a control channel (e.g., physical uplink control channel (PUCCH), etc.) related to the downlink resources. In this regard, for example, base station 104 can schedule additional resources, modify a resource assignment, etc. for the device 102 based at least in part on the control data. In one example, CQI reporting component 202 can transmit CQI related to the downlink resources to base station 104 over the control channel, which base station 104 can utilize in part to determine resource allocation.

In addition, for example, device 102 can determine to receive signals from one or more other base stations (e.g., initialize an autonomous gap for measuring related cells). For example, the receiving or measuring of signals from another base station can be part of a handover procedure (e.g., where more information is desired to be obtained from a femtocell access point), and/or the like. In this example, CQI reporting component 202 can transmit a low CQI (e.g., lower than an actual CQI) over the control channel to base station 104, such to lessen a likelihood that base station 104 schedules downlink resources to device 102 for a period of time. In this regard, upon receiving the low CQI, the base station 104 can refrain from scheduling resources to device 102 or at least schedule resources at a low data rate, as described. For example, to take advantage of multi-user diversity, base station 104 can attempt to generally schedule resources for devices during periods of good channel conditions (e.g., where reported CQI for the periods are above a threshold level). In either case, however, modulation and coding scheme (MCS) can be determined from the CQI, and thus, base station 104 can utilize an MCS corresponding to a low data rate based at least in part on the low CQI.

After reporting the low CQI, base station analyzing component 204 can receive signals from one or more other base stations (not shown). This can include, in one example, tuning away to another frequency to receive the signals. In an example, as described, the signals can relate to additional femtocell identification information for handover. Once desired information is received from the one or more other base stations, base station analyzing component 204 can tune back to a frequency of base station 104, and CQI reporting component 202 can transmit an improved CQI value (e.g., a higher CQI relative to the low CQI previously reported) to the base station 104 over the control channel. This can be an actual CQI as measured before reporting the low CQI value, a CQI computed from signals subsequently received from base station 104, and/or the like, or another improved CQI value. In this regard, base station 104 can, as described, at least select a more desirable MCS based on the CQI and/or attempt to schedule resources for device 102 in periods of good CQI.

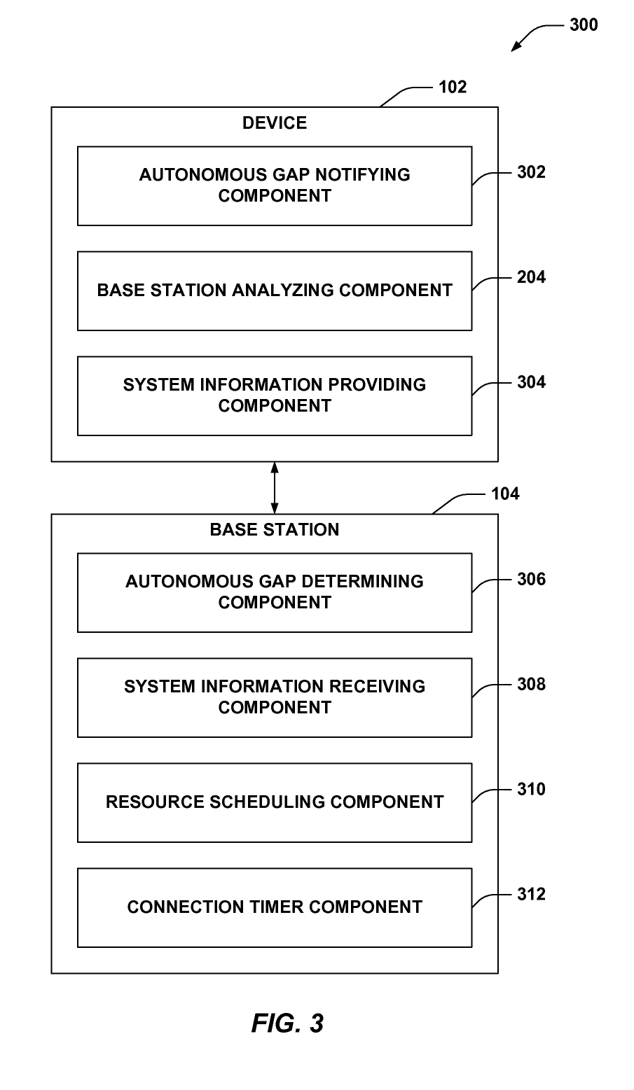

Referring to FIG. 3, illustrated is an example wireless communications system 300 that facilitates communicating with a serving base station and analyzing other base stations. System 300 comprises a device 102, which as described can communicate with a base station 104 to receive wireless network access. In this regard, for example, base station 104 can be a serving base station 104 of device 102. Device 102 can comprise an autonomous gap notifying component 302 that specifies one or more parameters regarding an autonomous gap to a serving base station for measuring one or more base stations. Device 102 also comprises a base station analyzing component 204 that receives signals from one or more base stations, and a system information providing component 304 that communicates system information from the signals to the serving base station.

In addition, base station 104 comprises an autonomous gap determining component 306 that receives one or more parameters regarding an autonomous gap at a device, during which the device measures one or more base stations, and a system information receiving component 308 that obtains one or more system information parameters for one or more base stations from device 102. Base station 104 further comprises a resource scheduling component 310 that allocates communications resources to the device based at least in part on the one or more parameters regarding the autonomous gap, and a connection timer component 312 that initializes a timer for determining whether to close a connection with the device after the beginning of an autonomous gap.

According to an example, base station 104 can allocate downlink resources to the device 102, and can transmit data to the device 102 over the downlink resources, as described. In addition, device 102 can receive signals from other base stations while communicating with base station 104 at least in part by determining an autonomous gap during which to measure the other base stations. In this regard, autonomous gap notifying component 302 can indicate beginning the autonomous gap to the base station 104. This can include signaling the beginning or other information to the base station. In one example, autonomous gap notifying component 302 can indicate the beginning of the autonomous gap by reporting a low CQI, as described. In another example, however, autonomous gap notifying component 302 can signal a CQI value reserved for indicating beginning an autonomous gap. In this regard, base station 104 can receive the CQI value, and autonomous gap determining component 306 can detect the beginning of the autonomous gap based at least in part on the reserved CQI value. Thus, resource scheduling component 310 can cease transmitting data to device 102 (e.g., by refraining from assigning resources to device 102 during the autonomous gap).

As described previously, base station analyzing component 204 can receive signals from other base stations during the autonomous gap, which can relate to, for example, system information of other femtocells to facilitate uniquely identifying the femtocells. Moreover, device 102 can tune away to another frequency to receive the signals, as described. System information providing component 304 can obtain such information from the system information signals, and can communicate the information to base station 104. System information receiving component 308 can obtain the information, and base station 104 can utilize the information for identifying the femtocells for handing over device 102 communications.

When device 102 has completed receiving signals from the one or more other base stations, and tunes back to the frequency of base station 104, autonomous gap notifying component 302 can signal the end of the autonomous gap. This can be an explicit signal, or where CQI is used to indicate the beginning, autonomous gap notifying component 302 can transmit the actual CQI value (or a value that indicates ending of the autonomous gap) to base station 104. Autonomous gap determining component 306 can obtain the indication and determine the end of the autonomous gap. In this example, resource scheduling component 310 can then continue transmitting data to the device (e.g., at least in part by assigning downlink resources to device 102, which can be based at least in part on an MCS selected for the actual CQI value). In another example, connection timer component 312 can initialize a timer once the beginning of the autonomous gap indication is received by autonomous gap determining component 306. In this example, if the indication of the ending of the autonomous gap is not received by autonomous gap determining component 306 before expiry of the timer, base station 104 can close the connection with device 102, for example.

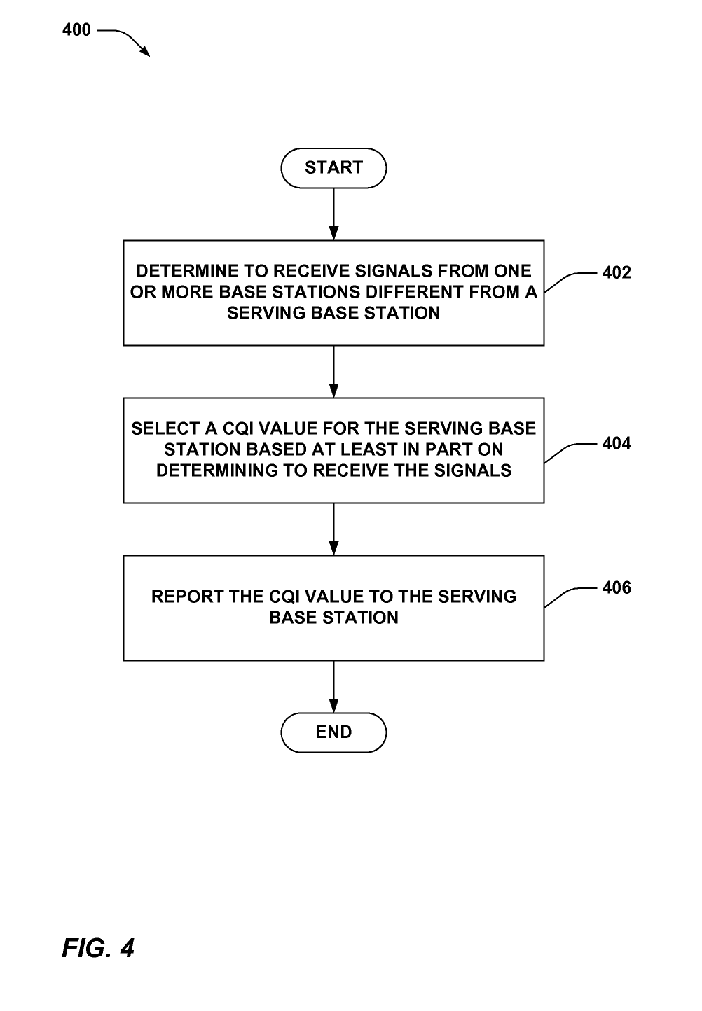

Referring to FIGS. 4-6, example methodologies relating to analyzing signals from one or more base stations while communicating with a serving base station are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Referring to FIG. 4, an example methodology 400 is displayed that facilitates reporting a CQI value to a serving base station that facilitates receiving signals from one or more other base stations. At 402, it can be determined to receive signals from one or more base stations different from a serving base station. As described, for example, the one or more base stations can be femtocells, for which additional identification information is required; thus, one or more system information signals can be received from the one or more base stations. At 404, a CQI value can be selected for the serving base station based at least in part on determining to receive the signals. For example, the CQI value can be a lower CQI value than an actual CQI related to resources assigned by the serving base station. Thus, as described, this can lessen a likelihood that the serving base station schedules resources based on the CQI value. In another example, the CQI value can be a value reserved for indicating an autonomous gap. At 406, the CQI value can be reported to the serving base station. In this regard, one or more signals can be received from the one or more base stations subsequent to reporting the CQI value, as described, and an actual CQI value can be reported to indicate the end of the autonomous gap.

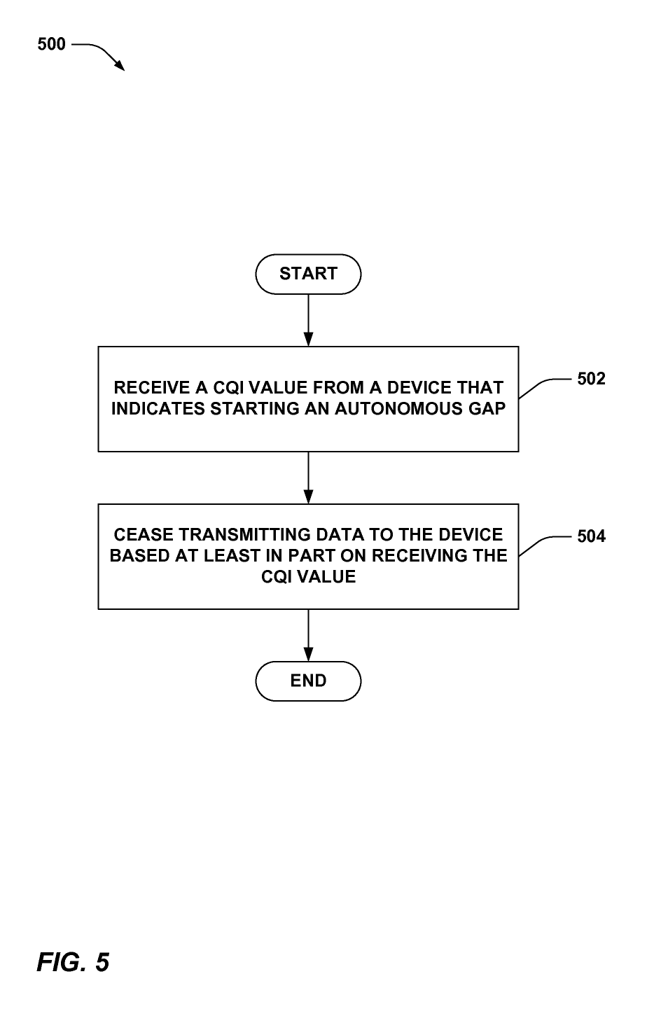

Turning to FIG. 5, an example methodology 500 is displayed that facilitates determining a start of an autonomous gap. At 502, a CQI value can be received from a device that indicates starting an autonomous gap. As described, for example, this can be a CQI value reserved for such a purpose to allow detection of the autonomous gap. At 504, transmitting data to the device can be ceased based at least in part on receiving the CQI value. Thus, for example, the device can tune away to measure signals from other base station, and data can be held until the device returns from the tune away.

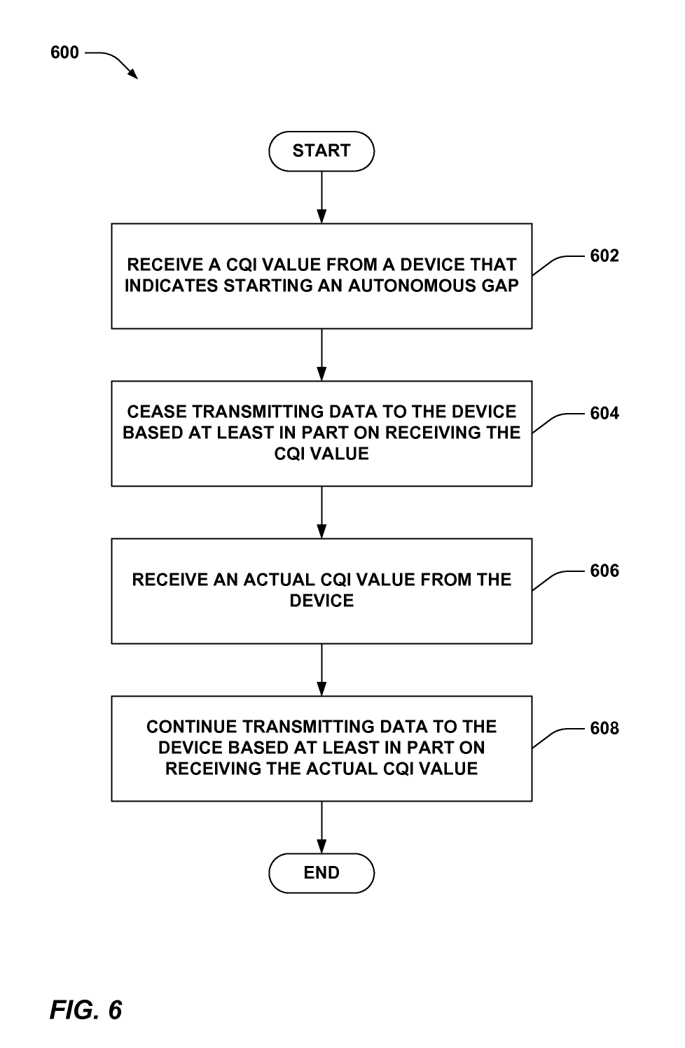

Referring to FIG. 6, illustrated is an example methodology 600 for controlling transmissions to a device based at least in part on detecting autonomous gaps. At 602, a CQI value can be received from a device that indicates starting an autonomous gap. As described, for example, this can be a CQI value reserved for such a purpose to allow detection of the autonomous gap. At 604, transmitting data to the device can be ceased based at least in part on receiving the CQI value. Thus, for example, the device can tune away to measure signals from other base station, and data can be held until the device returns from the tune away. In this regard, at 606, an actual CQI value can be received from the device. The actual CQI value can relate to a channel quality of resources assigned to the device. At 608, transmitting data to the device can be continued based at least in part on receiving the actual CQI value. This can include, for example, selecting a MCS and transmitting data over resources assigned to the device.

It will be appreciated that, in accordance with one or more aspects described herein, inferences can be made regarding determining a CQI value to decrease likelihood of resource assignment at a base station, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

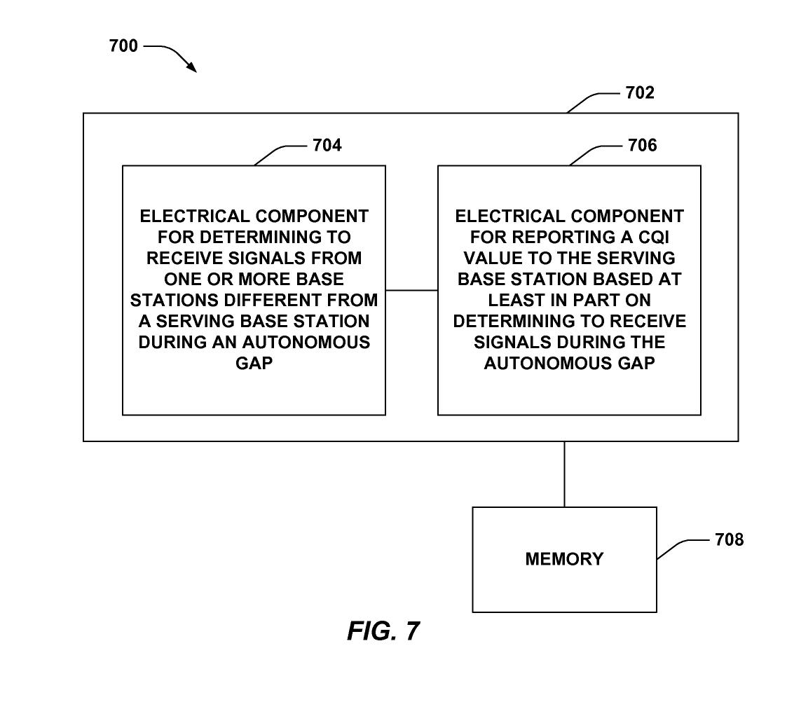

With reference to FIG. 7, illustrated is a system 700 that reports CQI for a subsequent autonomous gap to mitigate lost data. For example, system 700 can reside at least partially within a base station, mobile device, etc. It is to be appreciated that system 700 is represented as including functional blocks, which can be functional blocks that represent functions implemented by a processor, software, or combination thereof (e.g., firmware). System 700 includes a logical grouping 702 of electrical components that can act in conjunction. For instance, logical grouping 702 can include an electrical component for determining to receive signals from one or more base stations different from a serving base station during an autonomous gap 704. As described, this can include determining a start of the autonomous gap defined for system 700. Further, logical grouping 702 can comprise an electrical component for reporting a CQI value to the serving base station based at least in part on determining to receive signals during the autonomous gap 706. For example, the CQI can be a low CQI value (e.g., lower than an actual CQI), a value reserved for reporting a determination to receive the signals, etc. Additionally, system 700 can include a memory 708 that retains instructions for executing functions associated with the electrical components 704 and 706. While shown as being external to memory 708, it is to be understood that one or more of the electrical components 704 and 706 can exist within memory 708.

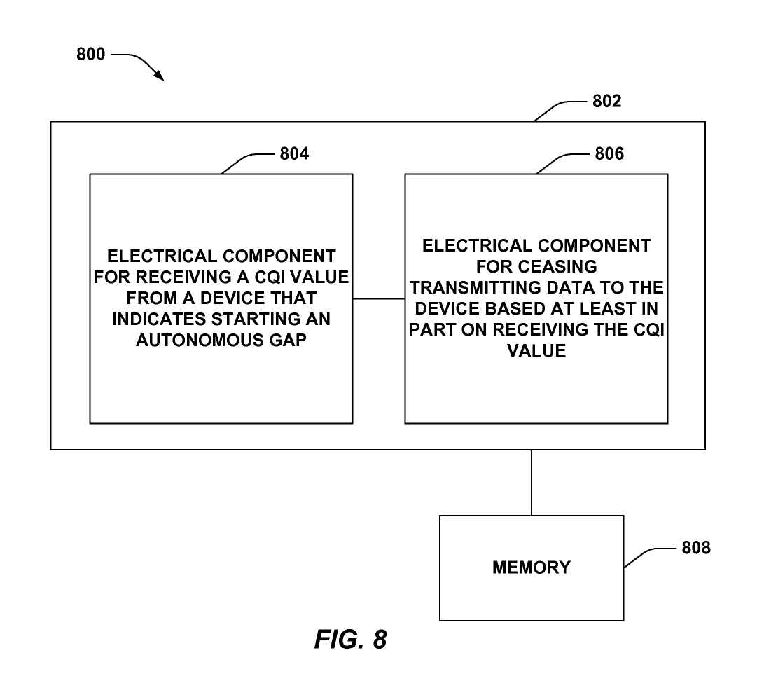

Turning to FIG. 8, illustrated is a system 800 that controls data transmissions to a device based at least in part on determining beginning of an autonomous gap. For example, system 800 can reside at least partially within a base station, mobile device, etc. It is to be appreciated that system 800 is represented as including functional blocks, which can be functional blocks that represent functions implemented by a processor, software, or combination thereof (e.g., firmware). System 800 includes a logical grouping 802 of electrical components that can act in conjunction. For instance, logical grouping 802 can include an electrical component for receiving a CQI value from a device that indicates starting an autonomous gap 804. For example, as described, the autonomous gap can relate to measuring signals from one or more other base stations (e.g., to determine system information for identifying the one or more other base stations in handover). Further, logical grouping 802 can comprise an electrical component for ceasing transmitting data to the device based at least in part on receiving the CQI value 806. As described, electrical component 806 can cease transmission until electrical component 804 receives another CQI value from the device, etc. Additionally, system 800 can include a memory 808 that retains instructions for executing functions associated with the electrical components 804 and 806. While shown as being external to memory 808, it is to be understood that one or more of the electrical components 804 and 806 can exist within memory 808.

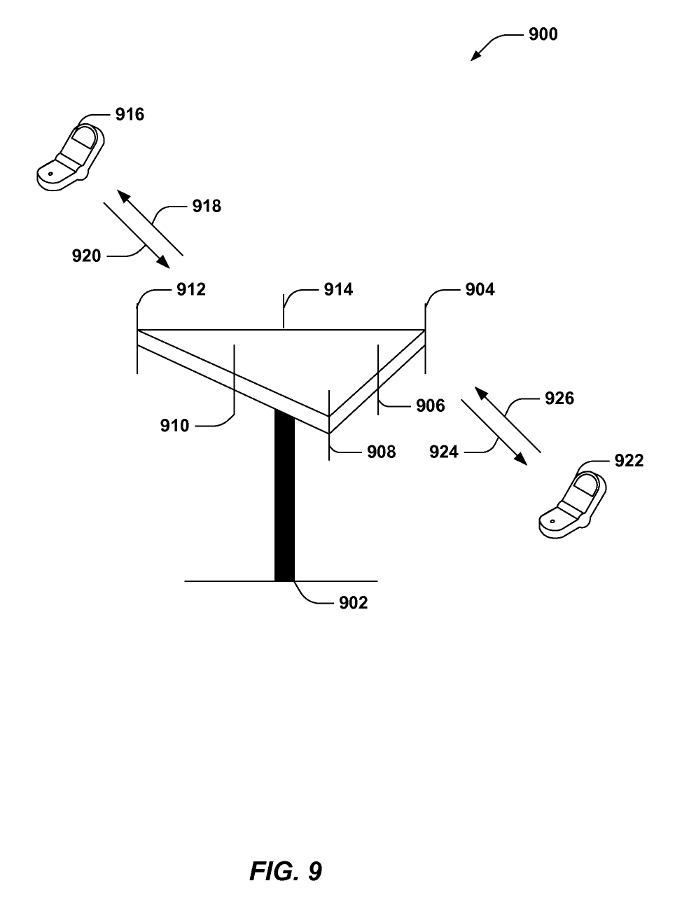

Referring now to FIG. 9, a wireless communication system 900 is illustrated in accordance with various embodiments presented herein. System 900 comprises a base station 902 that can include multiple antenna groups. For example, one antenna group can include antennas 904 and 906, another group can comprise antennas 908 and 910, and an additional group can include antennas 912 and 914. Two antennas are illustrated for each antenna group; however, more or fewer antennas can be utilized for each group. Base station 902 can additionally include a transmitter chain and a receiver chain, each of which can in turn comprise a plurality of components associated with signal transmission and reception (e.g., processors, modulators, multiplexers, demodulators, demultiplexers, antennas, etc.), as is appreciated.

Base station 902 can communicate with one or more mobile devices such as mobile device 916 and mobile device 922; however, it is to be appreciated that base station 902 can communicate with substantially any number of mobile devices similar to mobile devices 916 and 922. Mobile devices 916 and 922 can be, for example, cellular phones, smart phones, laptops, handheld communication devices, handheld computing devices, satellite radios, global positioning systems, PDAs, and/or any other suitable device for communicating over wireless communication system 900. As depicted, mobile device 916 is in communication with antennas 912 and 914, where antennas 912 and 914 transmit information to mobile device 916 over a forward link 918 and receive information from mobile device 916 over a reverse link 920. Moreover, mobile device 922 is in communication with antennas 904 and 906, where antennas 904 and 906 transmit information to mobile device 922 over a forward link 924 and receive information from mobile device 922 over a reverse link 926. In a frequency division duplex (FDD) system, forward link 918 can utilize a different frequency band than that used by reverse link 920, and forward link 924 can employ a different frequency band than that employed by reverse link 926, for example. Further, in a time division duplex (TDD) system, forward link 918 and reverse link 920 can utilize a common frequency band and forward link 924 and reverse link 926 can utilize a common frequency band.

Each group of antennas and/or the area in which they are designated to communicate can be referred to as a sector of base station 902. For example, antenna groups can be designed to communicate to mobile devices in a sector of the areas covered by base station 902. In communication over forward links 918 and 924, the transmitting antennas of base station 902 can utilize beamforming to improve signal-to-noise ratio of forward links 918 and 924 for mobile devices 916 and 922. Also, while base station 902 utilizes beamforming to transmit to mobile devices 916 and 922 scattered randomly through an associated coverage, mobile devices in neighboring cells can be subject to less interference as compared to a base station transmitting through a single antenna to all its mobile devices. Moreover, mobile devices 916 and 922 can communicate directly with one another using a peer-to-peer or ad hoc technology as depicted. According to an example, system 900 can be a multiple-input multiple-output (MIMO) communication system.

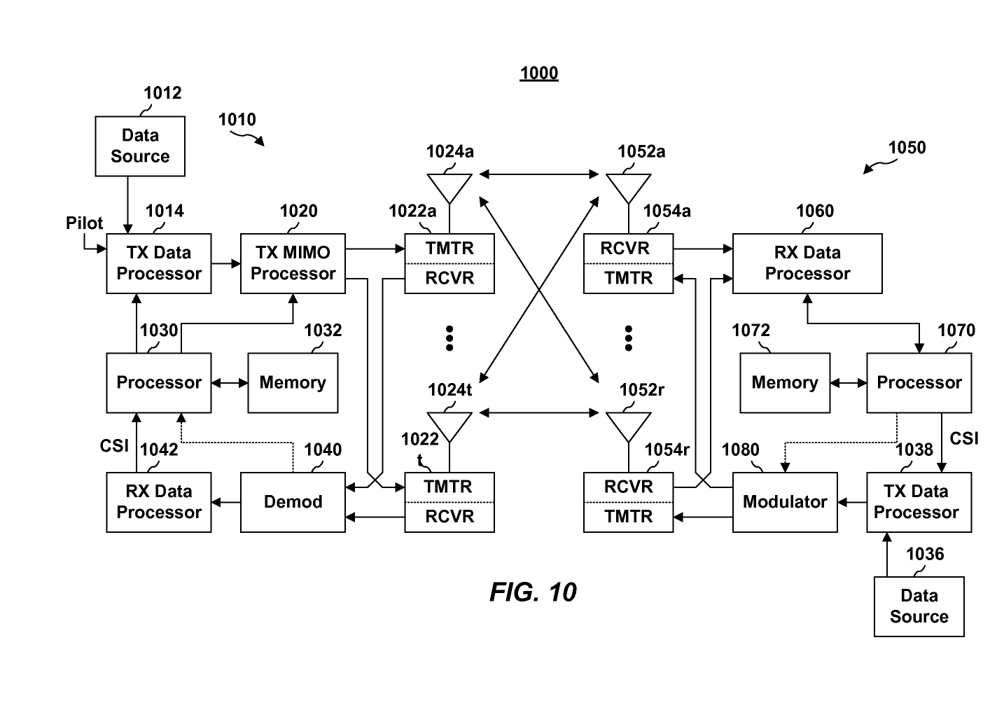

FIG. 10 shows an example wireless communication system 1000. The wireless communication system 1000 depicts one base station 1010 and one mobile device 1050 for sake of brevity. However, it is to be appreciated that system 1000 can include more than one base station and/or more than one mobile device, wherein additional base stations and/or mobile devices can be substantially similar or different from example base station 1010 and mobile device 1050 described below. In addition, it is to be appreciated that base station 1010 and/or mobile device 1050 can employ the systems (FIGS. 1-3 and 7-9) and/or methods (FIGS. 4-6) described herein to facilitate wireless communication there between.

At base station 1010, traffic data for a number of data streams is provided from a data source 1012 to a transmit (TX) data processor 1014. According to an example, each data stream can be transmitted over a respective antenna. TX data processor 1014 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1050 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1030.

The modulation symbols for the data streams can be provided to a TX MIMO processor 1020, which can further process the modulation symbols (e.g., for OFDM). TX MIMO processor 1020 then provides NT modulation symbol streams to NT transmitters (TMTR) 1022a through 1022t. In various embodiments, TX MIMO processor 1020 applies beamforming weights to the symbols of the data streams and to the antenna from which the symbol is being transmitted.

Each transmitter 1022 receives and processes a respective symbol stream to provide one or more analog signals, and further conditions (e.g., amplifies, filters, and upconverts) the analog signals to provide a modulated signal suitable for transmission over the MIMO channel. Further, NT modulated signals from transmitters 1022a through 1022t are transmitted from NT antennas 1024a through 1024t, respectively.

At mobile device 1050, the transmitted modulated signals are received by NR antennas 1052a through 1052r and the received signal from each antenna 1052 is provided to a respective receiver (RCVR) 1054a through 1054r. Each receiver 1054 conditions (e.g., filters, amplifies, and downconverts) a respective signal, digitizes the conditioned signal to provide samples, and further processes the samples to provide a corresponding “received” symbol stream.

An RX data processor 1060 can receive and process the NR received symbol streams from NR receivers 1054 based on a particular receiver processing technique to provide NT “detected” symbol streams. RX data processor 1060 can demodulate, deinterleave, and decode each detected symbol stream to recover the traffic data for the data stream. The processing by RX data processor 1060 is complementary to that performed by TX MIMO processor 1020 and TX data processor 1014 at base station 1010.

A processor 1070 can periodically determine which precoding matrix to utilize as discussed above. Further, processor 1070 can formulate a reverse link message comprising a matrix index portion and a rank value portion.

The reverse link message can comprise various types of information regarding the communication link and/or the received data stream. The reverse link message can be processed by a TX data processor 1038, which also receives traffic data for a number of data streams from a data source 1036, modulated by a modulator 1080, conditioned by transmitters 1054a through 1054r, and transmitted back to base station 1010.

At base station 1010, the modulated signals from mobile device 1050 are received by antennas 1024, conditioned by receivers 1022, demodulated by a demodulator 1040, and processed by a RX data processor 1042 to extract the reverse link message transmitted by mobile device 1050. Further, processor 1030 can process the extracted message to determine which precoding matrix to use for determining the beamforming weights.

Processors 1030 and 1070 can direct (e.g., control, coordinate, manage, etc.) operation at base station 1010 and mobile device 1050, respectively. Respective processors 1030 and 1070 can be associated with memory 1032 and 1072 that store program codes and data. Processors 1030 and 1070 can also perform computations to derive frequency and impulse response estimates for the uplink and downlink, respectively.

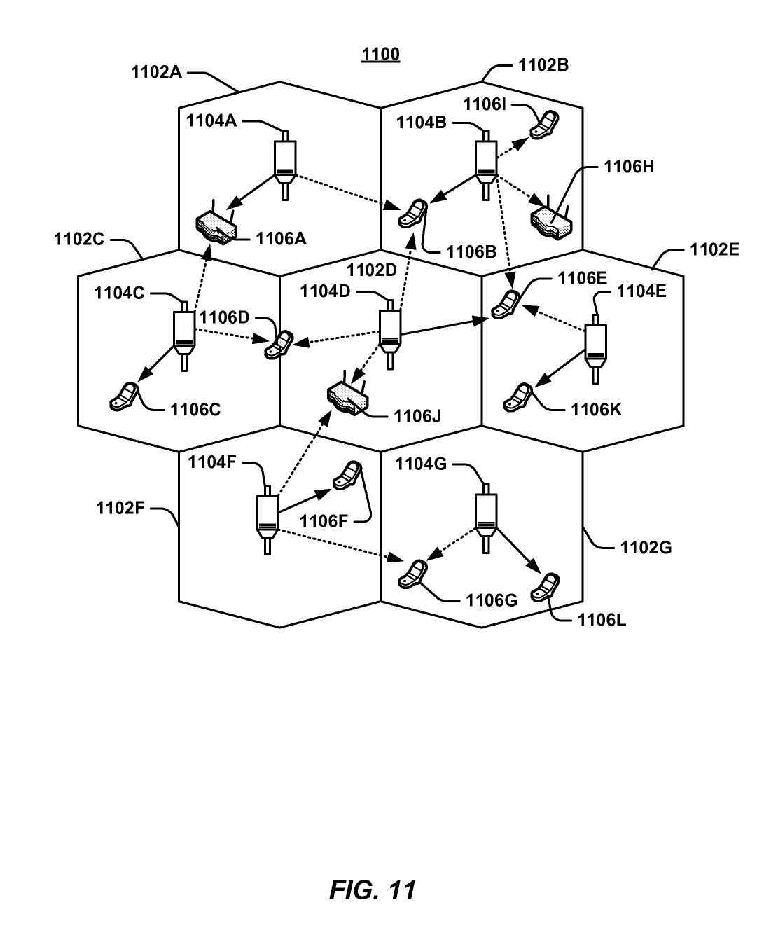

FIG. 11 illustrates a wireless communication system 1100, configured to support a number of users, in which the teachings herein may be implemented. The system 1100 provides communication for multiple cells 1102, such as, for example, macro cells 1102A-1102G, with each cell being serviced by a corresponding access node 1104 (e.g., access nodes 1104A-1104G). As shown in FIG. 11, access terminals 1106 (e.g., access terminals 1106A-1106L) can be dispersed at various locations throughout the system over time. Each access terminal 1106 can communicate with one or more access nodes 1104 on a forward link (FL) and/or a reverse link (RL) at a given moment, depending upon whether the access terminal 1106 is active and whether it is in soft handoff, for example. The wireless communication system 1100 can provide service over a large geographic region. For example, macro cells 1102A-1102G can cover a few blocks in a neighborhood.

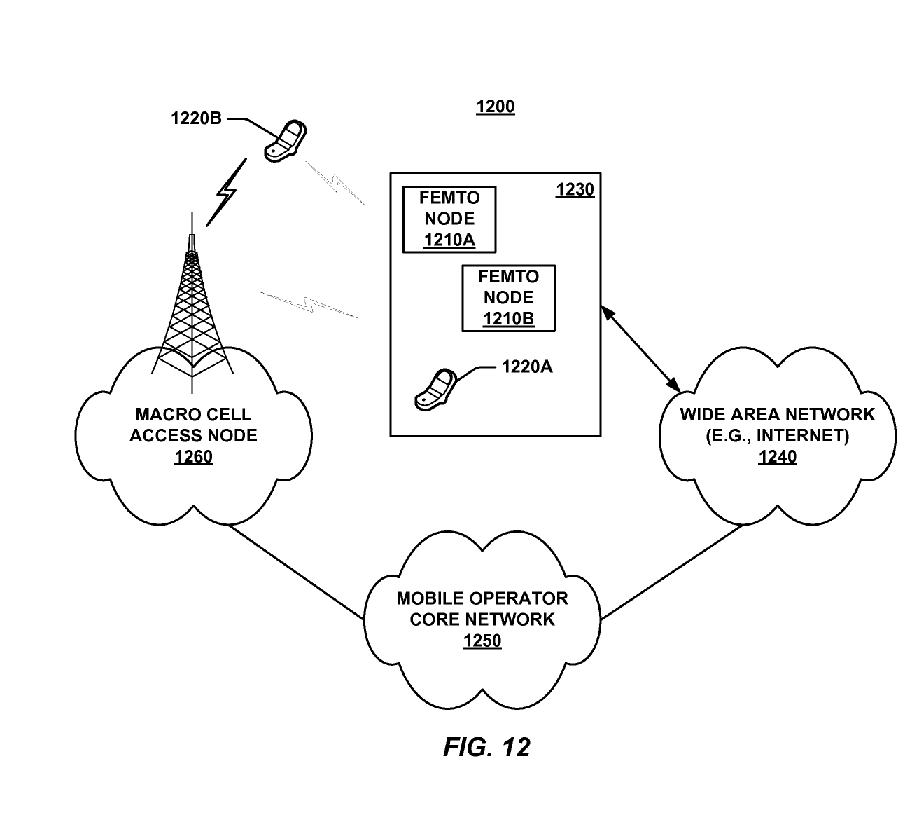

FIG. 12 illustrates an exemplary communication system 1200 where one or more femto nodes are deployed within a network environment. Specifically, the system 1200 includes multiple femto nodes 1210 (e.g., femto nodes or home Node B (HNB) 1210A and 1210B) installed in a relatively small scale network environment (e.g., in one or more user residences 1230). Each femto node 1210 can be coupled to a wide area network 1240 (e.g., the Internet) and a mobile operator core network 1250 via a digital subscriber line (DSL) router, a cable modem, a wireless link, or other connectivity means (not shown). As will be discussed below, each femto node 1210 can be configured to serve associated access terminals 1220 (e.g., access terminal 1220A) and, optionally, alien access terminals 1220 (e.g., access terminal 1220B). In other words, access to femto nodes 1210 can be restricted such that a given access terminal 1220 can be served by a set of designated (e.g., home) femto node(s) 1210 but may not be served by any non-designated femto nodes 1210 (e.g., a neighbor's femto node 1210).

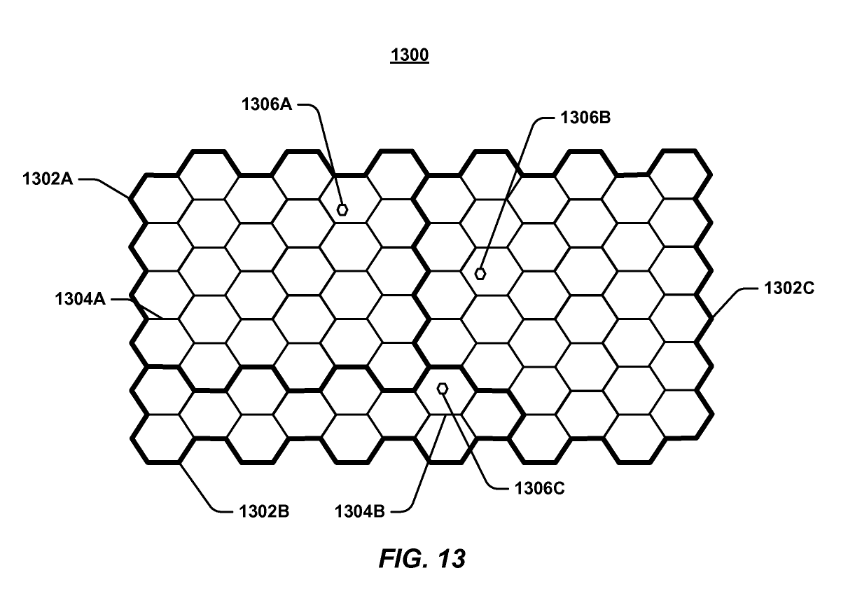

FIG. 13 illustrates an example of a coverage map 1300 where several tracking areas 1302 (or routing areas or location areas) are defined, each of which includes several macro coverage areas 1304. Here, areas of coverage associated with tracking areas 1302A, 1302B, and 1302C are delineated by the wide lines and the macro coverage areas 1304 are represented by the hexagons. The tracking areas 1302 also include femto coverage areas 1306. In this example, each of the femto coverage areas 1306 (e.g., femto coverage area 1306C) is depicted within a macro coverage area 1304 (e.g., macro coverage area 1304B). It should be appreciated, however, that a femto coverage area 1306 may not lie entirely within a macro coverage area 1304. In practice, a large number of femto coverage areas 1306 can be defined with a given tracking area 1302 or macro coverage area 1304. Also, one or more pico coverage areas (not shown) can be defined within a given tracking area 1302 or macro coverage area 1304.

Referring again to FIG. 12, the owner of a femto node 1210 can subscribe to mobile service, such as, for example, 3G mobile service, offered through the mobile operator core network 1250. In addition, an access terminal 1220 can be capable of operating both in macro environments and in smaller scale (e.g., residential) network environments. Thus, for example, depending on the current location of the access terminal 1220, the access terminal 1220 can be served by an access node 1260 of the macro cell mobile network 1250 or by any one of a set of femto nodes 1210 (e.g., the femto nodes 1210A and 1210B that reside within a corresponding user residence 1230). For example, when a subscriber is outside his home, he is served by a standard macro access node (e.g., node 1260) and when the subscriber is at home, he is served by a femto node (e.g., node 1210A). Here, it should be appreciated that a femto node 1220 can be backward compatible with existing access terminals 1220.

A femto node 1210 can be deployed on a single frequency or, in the alternative, on multiple frequencies. Depending on the particular configuration, the single frequency or one or more of the multiple frequencies can overlap with one or more frequencies used by a macro node (e.g., node 1260). In some aspects, an access terminal 1220 can be configured to connect to a preferred femto node (e.g., the home femto node of the access terminal 1220) whenever such connectivity is possible. For example, whenever the access terminal 1220 is within the user's residence 1230, it can communicate with the home femto node 1210.

In some aspects, if the access terminal 1220 operates within the macro cellular network 1250 but is not residing on its most preferred network (e.g., as defined in a preferred roaming list), the access terminal 1220 can continue to search for the most preferred network (e.g., the preferred femto node 1210) using a Better System Reselection (BSR), which can involve a periodic scanning of available systems to determine whether better systems are currently available, and subsequent efforts to associate with such preferred systems. With the acquisition entry, the access terminal 1220 can limit the search for specific band and channel. For example, the search for the most preferred system can be repeated periodically. Upon discovery of a preferred femto node 1210, the access terminal 1220 selects the femto node 1210 for camping within its coverage area.

A femto node can be restricted in some aspects. For example, a given femto node can only provide certain services to certain access terminals. In deployments with so-called restricted (or closed) association, a given access terminal can only be served by the macro cell mobile network and a defined set of femto nodes (e.g., the femto nodes 1210 that reside within the corresponding user residence 1230). In some implementations, a node can be restricted to not provide, for at least one node, at least one of: signaling, data access, registration, paging, or service.

In some aspects, a restricted femto node (which can also be referred to as a Closed Subscriber Group Home Node B) is one that provides service to a restricted provisioned set of access terminals. This set can be temporarily or permanently extended as necessary. In some aspects, a Closed Subscriber Group (CSG) can be defined as the set of access nodes (e.g., femto nodes) that share a common access control list of access terminals. A channel on which all femto nodes (or all restricted femto nodes) in a region operate can be referred to as a femto channel.

Various relationships can thus exist between a given femto node and a given access terminal. For example, from the perspective of an access terminal, an open femto node can refer to a femto node with no restricted association. A restricted femto node can refer to a femto node that is restricted in some manner (e.g., restricted for association and/or registration). A home femto node can refer to a femto node on which the access terminal is authorized to access and operate on. A guest femto node can refer to a femto node on which an access terminal is temporarily authorized to access or operate on. An alien femto node can refer to a femto node on which the access terminal is not authorized to access or operate on, except for perhaps emergency situations (e.g., 911 calls).

From a restricted femto node perspective, a home access terminal can refer to an access terminal that authorized to access the restricted femto node. A guest access terminal can refer to an access terminal with temporary access to the restricted femto node. An alien access terminal can refer to an access terminal that does not have permission to access the restricted femto node, except for perhaps emergency situations, for example, such as 911 calls (e.g., an access terminal that does not have the credentials or permission to register with the restricted femto node).

For convenience, the disclosure herein describes various functionality in the context of a femto node. It should be appreciated, however, that a pico node can provide the same or similar functionality for a larger coverage area. For example, a pico node can be restricted, a home pico node can be defined for a given access terminal, and so on.

A wireless multiple-access communication system can simultaneously support communication for multiple wireless access terminals. As mentioned above, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out system, a MIMO system, or some other type of system.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for minimizing data loss in autonomous gaps, comprising:
determining to receive signals from one or more base stations different from a serving base station;
selecting a channel quality indicator (CQI) value for the serving base station based at least in part on the determining to receive signals; and
reporting the CQI value to the serving base station.

2. The method of claim 1, further comprising tuning away to a different frequency to receive signals from the one or more base stations based at least in part on reporting the CQI value.

3. The method of claim 2, further comprising tuning back to a frequency of the serving base station based at least in part on receiving the signals.

4. The method of claim 3, further comprising communicating at least a portion of the signals to the serving base station.

5. The method of claim 3, further comprising reporting an actual CQI value to the serving base station based at least in part on receiving the signals.

6. The method of claim 2, wherein the reporting the CQI value includes reporting a reserved CQI value reserved for indicating an autonomous gap related to the tuning away.

7. The method of claim 1, further comprising determining an actual CQI of communications received over downlink resources assigned by the serving base station, wherein the reporting the CQI value includes reporting the CQI value as less than the actual CQI.

8. An apparatus for minimizing data loss in autonomous gaps, comprising:
at least one processor configured to:
initialize an autonomous gap for receiving signals from one or more base stations different from a serving base station;
select a channel quality indicator (CQI) value for indicating the autonomous gap; and
report the CQI value to the serving base station; and
a memory coupled to the at least one processor.

9. The apparatus of claim 8, wherein the at least one processor is further configured to tune away to a different frequency during the autonomous gap to receive signals from the one or more base stations.

10. The apparatus of claim 9, wherein the at least one processor is further configured to receive the signals from the one or more base stations and tune back to a frequency of the serving base station after receiving the signals.

11. The apparatus of claim 10, wherein the at least one processor is further configured to report an actual CQI to the serving base station based at least in part on tuning back to the frequency.

12. The apparatus of claim 8, wherein the at least one processor selects the CQI value as a reserved CQI value for indicating autonomous gaps.

13. The apparatus of claim 8, wherein the at least one processor is further configured to determine an actual CQI of communications received over downlink resources assigned by the serving base station, wherein the at least one processor selects the CQI value to be less than the actual CQI.

14. An apparatus for minimizing data loss in autonomous gaps, comprising:
means for determining to receive signals from one or more base stations different from a serving base station during an autonomous gap; and
means for reporting a channel quality indicator (CQI) value to the serving base station based at least in part on the means for determining determining to receive the signals during the autonomous gap.

15. The apparatus of claim 14, wherein the means for determining tunes away to a different frequency to receive signals from the one or more base stations based at least in part on the CQI value.

16. The apparatus of claim 15, wherein the means for determining further tunes back to a frequency of the serving base station based at least in part on receiving the signals.

17. The apparatus of claim 15, wherein the means for reporting the CQI value reports an actual CQI value to the serving base station based at least in part on receiving the signals from the one or more base stations.

18. The apparatus of claim 14, wherein the CQI value is reserved for indicating tuning away to receive signals from the one or more base stations.

19. The apparatus of claim 14, wherein the means for reporting determines an actual CQI value for communications received over downlink resources assigned by the serving base station, and reports the CQI value as less than the actual CQI value.

20. A computer program product for minimizing data loss in autonomous gaps, comprising:
a computer-readable medium, comprising:
code for causing at least one computer to initialize an autonomous gap for receiving signals from one or more base stations different from a serving base station;
code for causing the at least one computer to select a channel quality indicator (CQI) value for indicating the autonomous gap; and
code for causing the at least one computer to report the CQI value to the serving base station.

21. The computer program product of claim 20, wherein the computer-readable medium further comprises code for causing the at least one computer to tune away to a different frequency during the autonomous gap to receive signals from the one or more base stations.

22. The computer program product of claim 21, wherein the computer-readable medium further comprises code for causing the at least one computer to receive the signals from the one or more base stations and tune back to a frequency of the serving base station after receiving the signals.

23. The computer program product of claim 22, wherein the computer-readable medium further comprises code for causing the at least one computer to report an actual CQI to the serving base station based at least in part on tuning back to the frequency.

24. The computer program product of claim 20, wherein the code for causing the at least one computer to select selects the CQI value as a reserved CQI value for indicating autonomous gaps.

25. The computer program product of claim 20, wherein the computer-readable medium further comprises code for causing the at least one computer to determine an actual CQI of communications received over downlink resources assigned by the serving base station, wherein the code for causing the at least one computer to select selects the CQI value to be less than the actual CQI.

26. An apparatus for minimizing data loss in autonomous gaps, comprising:
a base station analyzing component for determining to receive signals during an autonomous gap from one or more base stations different from a serving base station; and
a channel quality indicator (CQI) reporting component for communicating a CQI value to the serving base station based at least in part on the base station analyzing component determining to receive signals during the autonomous gap.

27. The apparatus of claim 26, wherein the base station analyzing component tunes away to a different frequency to receive signals from the one or more base stations based at least in part on the CQI value.

28. The apparatus of claim 27, wherein the base station analyzing component further tunes back to a frequency of the serving base station based at least in part on receiving the signals.

29. The apparatus of claim 27, wherein the CQI reporting component communicates an actual CQI value to the serving base station based at least in part on receiving the signals from the one or more base stations.

30. The apparatus of claim 26, wherein the CQI value is reserved for indicating tuning away to receive signals from the one or more base stations.

31. The apparatus of claim 26, wherein the CQI reporting component determines an actual CQI value for communications received over downlink resources assigned by the serving base station, and communicates the CQI value as less than the actual CQI value.

32. A method of wireless communication, comprising:
receiving a channel quality indicator (CQI) value from a device that indicates starting an autonomous gap; and
ceasing transmitting data to the device based at least in part on receiving the CQI value.

33. The method of claim 32, further comprising:
receiving an actual CQI value from the device; and
continuing transmitting data to the device based at least in part on receiving the actual CQI value.

34. The method of claim 33, wherein the continuing transmitting data to the device includes assigning resources to the device according to a modulation and coding scheme selected based at least in part on the CQI.

35. The method of claim 32, further comprising initializing a timer upon receiving the CQI value.

36. The method of claim 35, further comprising closing a connection with the device based at least in part on expiry of the timer before receiving a different CQI value from the device.

37. An apparatus for determining an autonomous gap, comprising:
at least one processor configured to:
receive a channel quality indicator (CQI) value from a device that indicates starting an autonomous gap; and
cease transmitting data to the device based at least in part on receiving the CQI value; and
a memory coupled to the at least one processor.

38. The apparatus of claim 37, wherein the at least one processor is further configured to:
receive an actual CQI value from the device; and
continue transmitting data to the device based at least in part on the actual CQI value.

39. The apparatus of claim 37, wherein the at least one processor is further configured to initialize a timer upon receiving the CQI value.

40. The apparatus of claim 39, wherein the at least one processor is further configured to close a connection with the device based at least in part on expiry of the timer before receiving a different CQI value from the device.

41. An apparatus for determining an autonomous gap, comprising:
means for receiving a channel quality indicator (CQI) value from a device that indicates starting an autonomous gap; and
means for ceasing transmitting data to the device based at least in part on receiving the CQI value.

42. The apparatus of claim 41, wherein the means for receiving receives an actual CQI value from the device, and the means for ceasing continues transmitting data to the device based at least in part on the actual CQI value.

43. The apparatus of claim 41, further comprising means for initializing a timer upon receiving the CQI value, wherein expiry of the timer causes cancellation of a connection with the device.

44. A computer program product for determining an autonomous gap, comprising:
a computer-readable medium, comprising:
code for causing at least one computer to receive a channel quality indicator (CQI) value from a device that indicates starting an autonomous gap; and
code for causing the at least one computer to cease transmitting data to the device based at least in part on receiving the CQI value.

45. The computer program product of claim 44, wherein the computer-readable medium further comprises:
code for causing the at least one computer to receive an actual CQI value from the device; and
code for causing the at least one computer to continue transmitting data to the device based at least in part on the actual CQI value.

46. The computer program product of claim 44, wherein the computer-readable medium further comprises code for causing the at least one computer to initialize a timer upon receiving the CQI value.

47. The computer program product of claim 46, wherein the computer-readable medium further comprises code for causing the at least one computer to close a connection with the device based at least in part on expiry of the timer before receiving a different CQI value from the device.

48. An apparatus for determining an autonomous gap, comprising:
an autonomous gap determining component for receiving a channel quality indicator (CQI) value from a device that indicates starting an autonomous gap; and
a resource scheduling component for ceasing transmitting data to the device based at least in part on receiving the CQI value.

49. The apparatus of claim 48, wherein the autonomous gap determining component receives an actual CQI value from the device, and the resource scheduling component continues transmitting data to the device based at least in part on the actual CQI value.

50. The apparatus of claim 48, further comprising a connection timer component for initializing a timer upon receiving the CQI value, wherein expiry of the timer causes cancellation of a connection with the device.
